(19) United States
(12) Patent Application Publication
(10) Pub. No.: US 2017/0026444 A1
(43) Pub. Date: Jan. 26, 2017

(54) POLICY DRIVEN MEDIA CONSUMPTION FRAMEWORK

(71) Applicant: AIRWATCH LLC, Atlanta, GA (US)

(72) Inventors: MANJUNATH BHAT, Bangalore (IN); NITIN SETHI, Bangalore (IN); THEJO NAIDU, Bangalore (IN)

(21) Appl. No.: 14/854,084

(22) Filed: Sep. 15, 2015

(30) Foreign Application Priority Data
Jul. 24, 2015 (IN) 3811/CHE/2015

(51) Int. Cl. H04L 29/06; H04L 29/08

(52) U.S. Cl. CPC H04L 65/602; H04L 67/42; H04L 65/4084; H04L 67/327; H04L 65/80

(57) ABSTRACT

Disclosed are various examples of providing a client device with media content based on policies applied to the client devices. A computing device receives a request for media content from a client device. A computing device also receives a device identifier and a current device context from the client device. The computing device identifies a policy applicable to the requested media content based at least in part on the current device context. The computing device then selects a component of the media content to send to the client device based at least in part on the applicable policy. Finally, the computing device sends the selected component of the media content to the client device.

Benefit is claimed under 35 U.S.C. 119(a)-(d) to Foreign application Serial No. 3811/CHE/2015 filed in India entitled “POLICY DRIVEN MEDIA CONSUMPTION FRAMEWORK”, on Jul. 24 2015, by AIRWATCH LLC, which is herein incorporated in its entirety by reference for all purposes

### BACKGROUND

Mobile computing devices, such as smartphones, tablets, or other devices can playback a wide variety of media content. For example, mobile computing devices can play video content, audio content, or render text for a user to read. However, playback of media content is often limited to the type of media content requested. If a user requests to watch a video, they will be provided with the requested video and not another form of the content, such as a podcast of the audio tracks of the video or a transcript of any dialog in the video.

Each version of media content can be more appropriate than another version for certain circumstances. For example, bandwidth intensive video may be in appropriate where network bandwidth is limited (e.g., dial-up connections) or expensive (e.g., roaming charges for mobile phone data usage). In such instances, audio or text may be preferable to video because they require less bandwidth. As another example, video or audio content may be inappropriate in certain locations, such as a library, due to their ability to distract others with sound. In such instances, a user may prefer a text transcript or a text article instead of a video clip or the audio track of the video clip.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting the operation of various examples of the disclosure.

FIG. 2 is a schematic block diagram depicting a networked environment according to various examples of the present disclosure.

FIG. 3 is a flowchart illustrating one example of functionality according to various examples of the disclosure.

FIG. 4 is a flowchart illustrating one example of functionality according to various examples of the disclosure.

### DETAILED DESCRIPTION

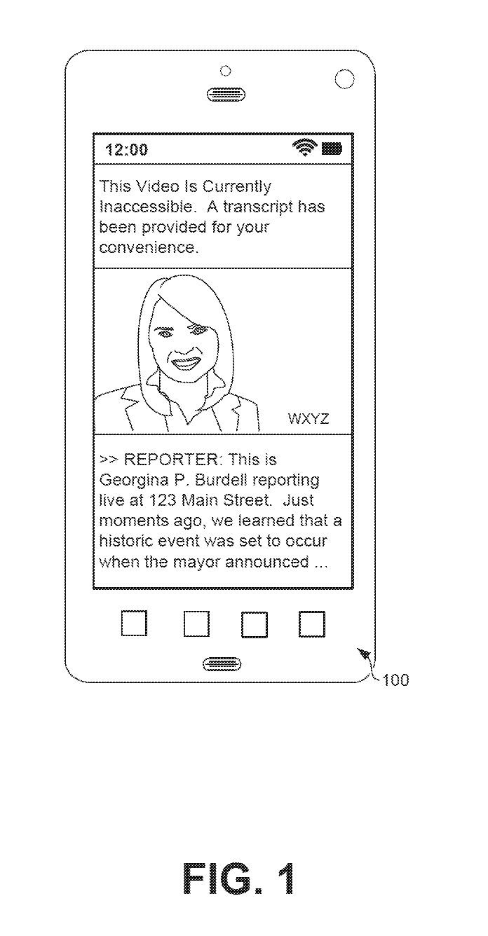

With reference to FIG. 1, shown is an example of a computing device 100 executing an application. As depicted, a client device 100 has requested a video. However, the video is inaccessible. For example, the network connection can have insufficient bandwidth to stream the video. Or the client device 100 can not have permission to stream the video at the current time. For example, the client device 100 can be connected to a cellular network or can be in a location where video streaming could be disruptive (e.g., a library or a classroom), and therefore the client device 100 has been prohibited from streaming the video in order to save on cellular data charges or minimize classroom disruptions. Accordingly, the user of the client device 100 has been provided with a text transcript of the video as an alternative format for consuming the content of the video. By automatically generating the text transcript and providing it to the client device 100, cellular data usage has been conserved or disruptions to other individuals in the library or classroom have been avoided.

When changes in the current state or context of the client device 100 occur, the client device 100 can be provided with other media formats for consuming the content of the video. For example, the client device can be provided with streaming video when the client device switches from a cellular network to Wi-Fi network that does not require the use of expensive cellular data. As another example, when the location of the client device 100 changes from the library or classroom to the user's home, the client device 100 can be provided with a stream of the video because disruptions of the classroom or library environment are no longer a concern.

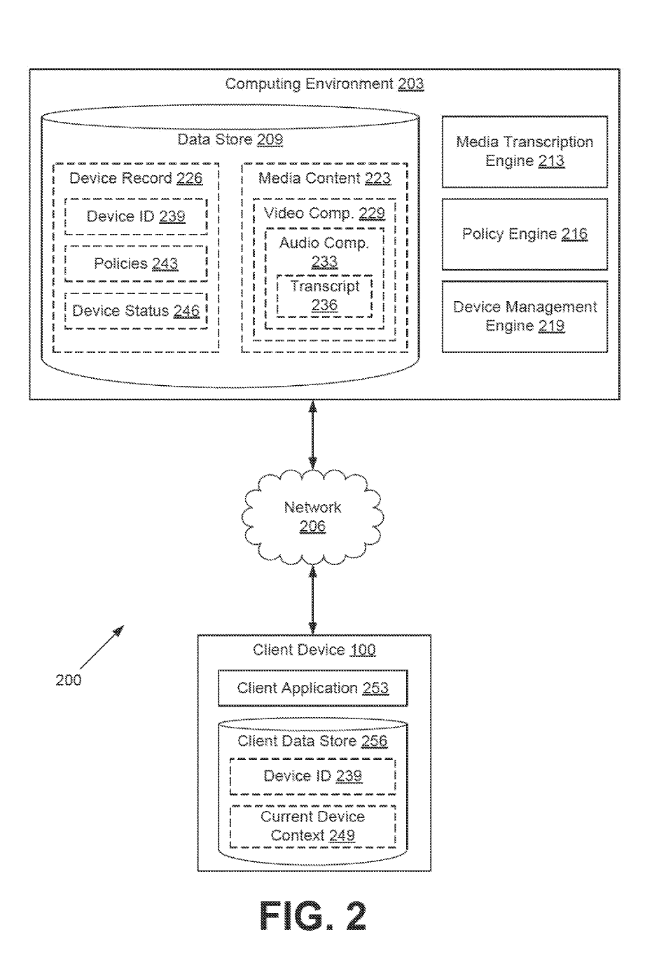

With reference to FIG. 2, shown is a networked environment 200 according to various embodiments. The networked environment 200 includes a computing environment 203 and a client device 100, which are in data communication with each other via a network 206. The network 206 includes, for example, the Internet, intranets, extranets, wide area networks (WANs), local area networks (LANs), wired networks, wireless networks, other suitable networks, or any combination of two or more such networks. For example, such networks can comprise satellite networks, cable networks, Ethernet networks, and other types of networks.

The computing environment 203 can comprise, for example, a server computer or any other system providing computing capability. Alternatively, the computing environment 203 can employ a plurality of computing devices that can be arranged, for example, in one or more server banks or computer banks or other arrangements. Such computing devices can be located in a single installation or can be distributed among many different geographical locations. For example, the computing environment 203 can include a plurality of computing devices that together can comprise a hosted computing resource, a grid computing resource, or any other distributed computing arrangement. In some cases, the computing environment 203 can correspond to an elastic or virtualized computing resource where the allotted capacity of processing, network, storage, or other computing-related resources can vary over time.

Various applications or other functionality can be executed in the computing environment 203 according to various embodiments. Also, various data is stored in a data store 209 that is accessible to the computing environment 203. The data store 209 can be representative of a plurality of data stores 209. The data stored in the data store 209, for example, is associated with the operation of the various applications and functional entities described below.

The components executed on the computing environment 203, for example, can include a media transcription engine 213, a policy engine 216, a device management engine 219, and other applications, services, processes, systems, engines, or functionality not discussed in detail herein. However, in some instances, the policy engine 216 can be executed on the client device 100. The media transcription engine 213 can separate media content 223 into its constituent components or to convert one component of media content 223 into another component, as further described below. The policy engine 216 can determine which components of the media content 223 are to be sent to the client device 100 in response to a request for media content 223, as further described below. The device management engine 219 can analyze data collected from the client device 100 in order to manage media content 223 sent to the client device 100, as further described below.

The data stored in the data store 209 can include, for example, media content 223, device records 226, and potentially other data. In some instances, data can be stored in the data store 209 in encrypted form. The media content 223 can request content that is requested by a client device 100 for consumption, such as video (e.g., recorded video, or live streams), audio (e.g., podcasts, audio tracks of video content, or live audio streams), and text (e.g., articles, reports, memorandums, or transcripts of audio or video content). A device record 226 can represent information related to a client device 100.

Media content 223 can have multiple components as well. For example, media content 223 can include a video component 229. The video component 229 can include an audio component 233 as a sub component, such as an audio channel representing sounds or speech in a video. In some instances, the audio component 233 can be stored separately from the video component 229 instead of as a subcomponent of the video component 229. The audio component 233 can also include a transcript 236 as a subcomponent. The transcript 236 can include a textual representation of speech contained within the audio component 233. In some instances, the transcript 236 can be stored separately from the audio component 233 instead of as a subcomponent of the audio component 233.

A device record 226 can represent information identifying a client device 100 and information regarding how a client device 100 should be managed. For example, the device record 226 can include a device identifier 239 for a client device 100, one or more policies 243 to be enforced when a client device 100 requests media content 223, a device status 246 of the client device 100, as well as other data.

In some instances, the device identifier 239 can correspond to a unique identifier for the client device 100, which allows a single device record 226 to map to a single client device 100. In these instances, the device identifier 239 can include, for example, a serial number, media access control (MAC) address for a network interface of the client device 100, a device fingerprint, or other information that uniquely identifies a client device 100. In some instances, the device identifier 239 can also represent a unique user identifier, such as a username, which can serve to uniquely identify a client device 100 based on the user of the client device 100.

Policies 243 can include settings, permissions, or other configuration options that can be enforced when a client device 100 interacts with the computing environment 203. For example, a policy 243 can specify that certain actions be taken or specify that access to certain instances or components of media content 223 be limited based at least in part on the device status 246 or the current device context 249 of the client device 100. In some of these examples, the policy 243 can specify a minimum bandwidth required for a current network connection between the client device 100 and the computing environment 203 in order for the client device 100 to be authorized to receive specific components of media content 223. In some of these examples, the policy 243 can specify an authorized location in which the client device 100 is authorized to receive specific components of media content 223 (e.g., only the audio component 233 in some locations but any component of the media content 223 in other locations). In some of these examples, the policy 243 can specify that the client device 100 can only access media content 223 or specify components of media content 223 (e.g., the audio component 233 or a transcript 236) when connected to a Wi-Fi network with an SSID specified in the policy 243. In some examples, the policy 243 can specify that the client device 100 can only access media content 223 if the allotment of network usage is above a specified threshold. For example, a policy 243 may specify that a client device 100 can only download text if a data plan associated with the client device 100 has less than 0.5 GB left out of a monthly data allotment. In some instances, the same policy 243 can be applied to multiple client devices 100. In these instances, the same policy 243 can appear in multiple device records 226.

The device status 246 can represent information about the client device 100 acquired when the client device 100 was registered for use with the device management engine 219. The device status 246 can include ownership information (e.g., identity of owner), ownership status (e.g., personally owned, employer owned, or owned by another third party), device specifications (e.g., make, model, manufacturer, operating system version, hardware specifications, or other data), a list of software previously installed or authorized for installation on the client device 100, a list of authorized users of the client device 100, or potentially other data.

The client device 100 can be representative of a plurality of client devices that can be coupled to the network 206. The client device 100 can comprise, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client device 100 can include a display. The display can comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 100 can execute various applications such as a client application 253 or other applications. The client application 253 can be executed in a client device 100, for example, to access network content served up by the computing environment 203 or other servers, thereby rendering a user interface on the display. To this end, the client application 253 can comprise, for example, a browser or a dedicated application, and the user interface can comprise a network page, an application screen, or other user interface. The client device 100 can execute applications beyond the client application 253 such as, for example, email applications, social networking applications, word processors, spreadsheets, or other applications.

The client device 100 can also include a local client data store 256. The client data store 256 can be representative of one or more client data stores 256 of the client device 100. The client data store 256 can include, for example, the device identifier 239 of the client device 100 (such as a unique hardware identifier or a unique user identifier), a current device context 249 of the client device 100, or potentially other data. The device identifier 239 can serve to link the client device 100 to a device record 226 as previously described. The current device context 249 can represent the current state or states of the client device 100. For example, the current device context 249 can represent a current location (e.g., current latitude and longitude coordinates or an address associated with the current location) of the client device 100. The current device context 249 can also represent a bandwidth of a network connection between the client device 100 and another computing device in the computing environment 203. In various instances, the current device context 249 can represent a type of network connection (e.g., cellular, Wi-Fi, Ethernet, BlueTooth®, or other connection) between the client computing 100 device and a computing device within the computing environment 203. In some instances, the current device context 249 can also represent an identification of a current network 206 (e.g., the service set identifier (SSID) for a WiFi network) to which the client device 100 is connected. In other instances, the current device context 249 can represent a balance of data allotment, such as where 0.5 GB remains out of a monthly data allotment of 10 GB. In various instances, the current device context 249 can also represent or an ownership status (e.g., personally owned or owned by a third-party such as an employer) of the client device 100. In some examples, the current device context 249 is populated based on information obtained from one or more of the client device 100, the computing environment 203, or a network carrier or provider.

Next, a general description of the operation of the various components of the networked environment 200 is provided. To begin, the client device 100 is registered with the device management engine 219. As part of the registration process, a device record 226 is created that corresponds to the client device 100 being registered. In some instances, the client application 253 can provide a device identifier 239 to the device management engine 219 during the registration process. In other instances, the device management engine 219 can generate the device identifier 239.

As part of the registration process, one or more policies 243 can also be assigned to the client device 100. Any policies 243 assigned to the client device 100 can be stored in the device record 226 created for the registered client device 100. Some policies 243 can be assigned automatically, such as site-wide, division-wide, or company-wide policies. Other policies 243 can be manually selected to be assigned to the client device 100. For example, an administrator could manually select that certain policies 243 be assigned or that certain automatically assigned policies 243 be unassigned.

After registration is completed, the client application 253 can request to download media content 223 from the computing environment 203. The client application 253 can include the device identifier 239 for the client device 100 and the current device context 249 of the client device 100 in some instances. The device management engine 219 receives, intercepts, or is otherwise notified of the request.

After receiving the request, the device management engine 219 can determine whether the client device 100 is authorized to receive the requested media content 223. In some examples, the client application 253 can determine if the client device 100 is authorized to received the requested media content 223 and relay this authorization status to the device management engine 219. If the client device 100 is authorized, then the device management engine 229 can request that the policy engine 216 determine whether any policies 243 that have been assigned to the client device 100 currently apply based at least in part on the current device context 249 of the client device 100.

The policy engine 216 can identify one or more policies 243 that would apply to the request by comparing each policy 243 listed in the device record 226 for the client device 100 to the current device context 249. For example, if a policy 243 specifies that it is to be applied to the client device 100 when the client device 100 is connected to a cellular network, then the policy engine 216 would apply the policy 243 when the current device context 249 indicates that the client device 100 is connected to a cellular network. In some instances, however, the functionality of the policy engine 216 can be merged with or performed by the device management engine 219.

After the policy engine 216 identifies one or more applicable policies 243, the device management engine 219 determines which components, if any, of the media content 226 that the client application 253 can download. The policy engine 216 can, for example, apply the most restrictive applicable policy to the client application 253. As an example, if a first policy 243 permits the client device 100 to access all components of the media content 223 but a second policy 246 that is also currently applicable limits the client device 100 to only the audio component 233, then the device management engine 219 could determine that the client application 253 is only allowed to access the audio component 233 of the requested media content.

The device management engine 219 can take one or more of several actions in response to determining that the client application 253 is limited to a particular set or subset of components of the media content 223. In some instances, the accessible component can be automatically provided to the client application 253. For example, if the client application requested a video, but is only allowed to access the audio component 233 of the video as a result of the currently applicable policies, the device management engine 219 might automatically send the audio component 233 to the client application 253 in response to the video. In other instances, the device management engine 219 can prompt the client application 253 to confirm that the user wants to proceed with downloading the audio component 233 or whether the user wishes to cancel the download.

Once the device management engine 219 determines which components of the media content 223 are to be sent to the client application 253, it sends the components to the client application 253 across the network 206.

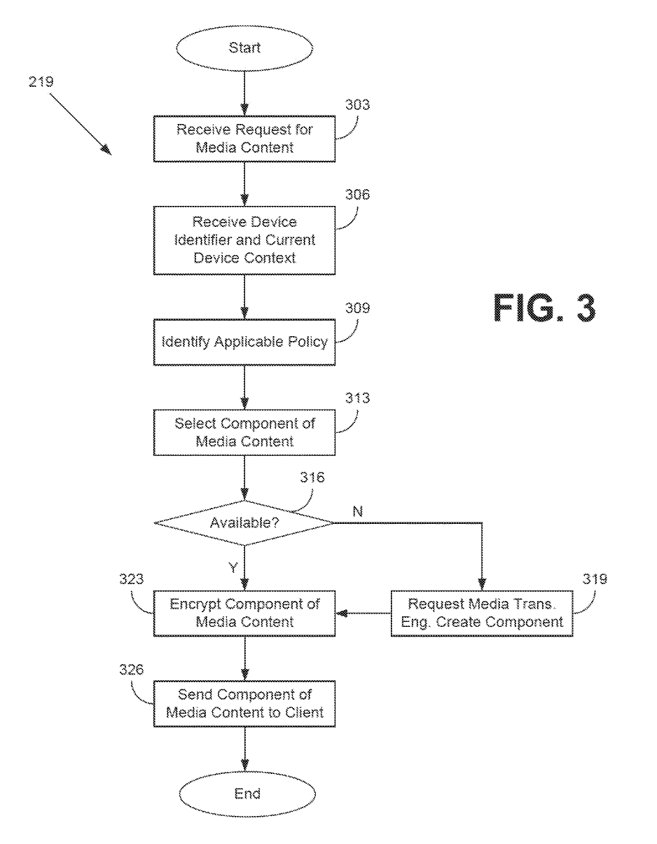

Referring next to FIG. 3, shown is a flowchart that provides one example of the operation of a portion of the device management engine 219. As an alternative, the flowchart of FIG. 3 can be viewed as depicting an example of elements of a method implemented in the computing environment 203.

Beginning with step 303, the device management engine 219 receives or is notified of a request from the client device 100 for media content 223. For example, the device management engine 219 can receive the request directly or can be notified by the server that provides the media content 223 of the request.

Proceeding next to step 306, the device management engine 219 receives or otherwise obtains the device identifier 239 and the current device identifier 249 from the client device 100. For example, the device identifier 239 and the current device identifier 249 can have been included in the original request for media content 223. In some instances, however, the device management engine 219 can send a request to the client device 100 for the device identifier 239 and the current device identifier 249 and receive them in response.

Moving on to step 309, the device management engine 219 can determine any policies 243 applicable to the request. In some instances, the device management engine 219 can query the policy engine 216, which can return the applicable policies 243 in response to being provided with a device identifier 239, the current device identifier 249, and an identification of the requested media content 223. In other instances, the device management engine 219 itself can retrieve the policies 243 listed in the device record 226 for the client device 100 and determine which policies 243 apply based at least in part on a comparison of the current device identifier 249 and the requested media content 223 with the policies 243 identified by the device record 226. For example, if the current device identifier 249 indicates that the client device 100 is connected to a cellular network, then a policy 243 that limits the access of the client application to the audio component 233 or the transcript 236 of the media content 233 (in order to save on data usage) can be found to be applicable. As another example, if the current device identifier 249 indicates that the client device 100 is located in a classroom or attached to a Wi-Fi network associated with a classroom, then another policy 243 can state that only a text transcript 236 of the media content 236 can be downloaded in order to prevent disruptions to other students caused by playing audio or video.

Referring next to step 313, the device management engine 219 can select a component of the media content 223 to be used to respond to the request from the client application 253. In some instances, the policy engine 216 can also specify the component or components of the media content 223 that the client application 253 is allowed to currently access based at least in part on the applicable policies identified previously in step 309. In other instances, the component of the media content 223 can be selected based at least in part on the permissions specified by the applicable policy 243 or policies 243. Where two or more policies 243 are found to be applicable, a selection of the component or components of the media content 223 that satisfy all of the applicable policies 243 can be selected, such as in the example provided in the discussion of step 309 above.

Proceeding next to step 316, the device management engine 219 determines if the selected component of the media content 223 is available. In some instances, the selected component, such as a text transcript 236, may not be available because it has not yet been created. In these instances, execution of the process proceeds to step 319. However, if the selected component is available, then execution of the process proceeds to step 323.

Moving on to step 319, the device management engine 219 can send a request to the media transcription engine 213 to create the selected component of the media content 223. For example, the device management engine 219 can request that the media transcription engine 213 separate the audio component 233 from the video component 229 of the media content 223. As another example, the device management engine 219 can request that the media transcription engine 213 generate a text transcript 236 of the media content 223, which the media transcription engine 213 can produce using various speech-to-text approaches. Once the media transcription engine 213 generates the selected component of the media content 223, execution of the process proceeds to step 323.

Proceeding next to step 323, the device management engine 219 can encrypt the selected component of the media content 223. Encryption can be performed using any one or more of a number of algorithms or approaches. For example, the selected component can be encrypted using a symmetric encryption algorithm (e.g., AES) with a key shared between the device management engine 219 and the client application 253. As another example, the selected component can be encrypted using an asymmetric encryption algorithm (e.g., RSA) using a public key provided by the client application 253.

Referring next to step 326, the device management engine 219 sends the component to the client application 253. Execution of the process subsequently ends.

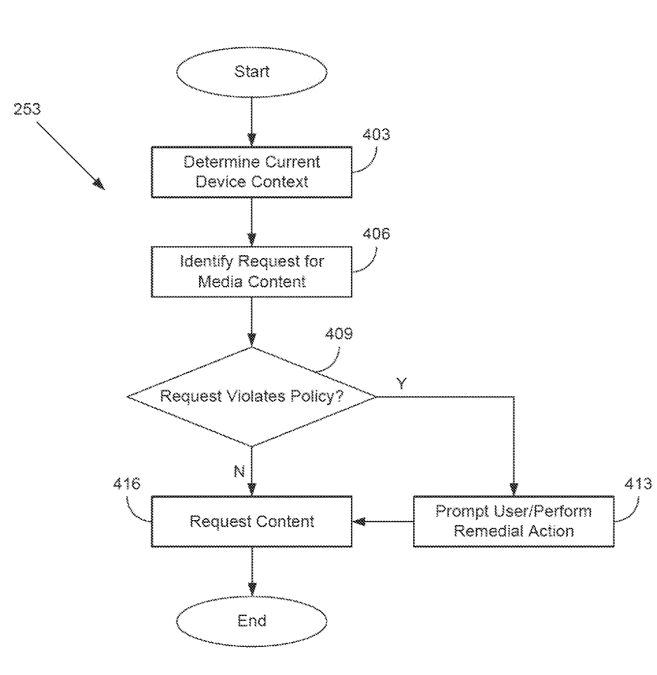

Referring next to FIG. 4, shown is a flowchart that provides one example of the operation of a portion of the client application 523. As an alternative, the flowchart of FIG. 3 can be viewed as depicting an example of elements of a method implemented in the client device 100.

Beginning with step 403, the client application 253 can determine the current device context 249 for the client device 100. The client application 253 can determine various aspects of the current state of the client device 100 by querying various sensors, hardware circuits, or the operating system of the client device 100. For example, the client application 253 can use an application programming interface (API) provided by the operating system of the client device 100 to determine the current type of network the client device 100 is connected to (e.g., cellular, Wi-Fi, wired Ethernet, BlueTooth, or other networks). As another example, the client application 253 can identify the current location of the client device 100 by retrieving a current set of coordinates from a global positioning system (GPS) receiver linked to the client device 100. Similarly, the client application 253 can identify the current time or date by retrieving these values from a clock linked to the client device 100 or using an API provided by the operating system for that purpose. In some instances, the client application 253 can request data from third-party services, such as a data balance from a network provider or user information from Microsoft Exchange® or Microsoft Active Directory®, in order to determine the device context 249 for the client device 100. For

Proceeding to step 406, the client application 253 can identify a request for media content 223 originating from the client device 100. For example, the client application 253 can identify a request that it is making itself or, in some instances, the client application 253 can be notified by the operating system that another application executing on the client device 100 is requesting media content 253.

Moving on to step 409, the client application 253 can determine whether the request for media content 253 violates a policy 243 based at least in part on the current device context 249. For example, the client device 100 can determine that because a smartphone is set to silent mode, that downloading a video component 229 or an audio component 233 of media content 223 would violate a policy 243 specifying that a phone in silent mode not render media content 223 with audio. As another example, the client device 100 can determine that a meeting is in progress based on a comparison of the current time to a user's calendar and that downloading a video component 229 or an audio component 233 would violate a policy 243 specifying that audible media content not be downloaded during meetings. If the client application 253 determines that the request for media content 223 would violate a policy 243, then execution of the process proceeds to step 413. Otherwise, execution of the process skips to step 416.

Referring next to step 413, the client application 253 can prompt the user to confirm a particular course of action. For example, if downloading a video component 229 or audio component 233 of media content 223 would violate a policy 243 because a smartphone is currently in silent mode, the client application 253 might prompt the user to download a transcript 236 instead. As another example, the client application 253 might prompt the user to switch the smartphone out of silent mode or confirm that the user wants to override the policy 243 and download the video component or audio component 233 of the requested media content 223.

However, in some instances, the client application 253 may instead perform one or more remedial actions at step 413. For example, if downloading a video component 229 of media content 223 would violate a policy 243 restricting access to the video component 229 of the media content 223 to specific client devices 100 or users of client devices 100, the client application 253 could disable the network adapter of the client device 100. As another example, the client application 253 could instead suspend, disable, or kill the application downloading the video component 229 of the media content 223. Similar actions could be taken if other policies 243 were violated.

Proceeding next to step 416, the client application 253 sends the request for media content 223 to the device management engine 219. In those instances where another application on the client device 100 requested the media content 223, the client application 253 can approve the original request or modify the request to comply with a policy 243, as described above. Execution of the process subsequently ends.

The flowcharts of FIG. 3 and FIG. 4 show an example of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIG. 3 and FIG. 4 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages might be added to the logical flow described herein, for purposes of enhanced utility, accounting, performance measurement, or troubleshooting aid. It is understood that all such variations are within the scope of the present disclosure.

The computers within the computing environment 203, the client device 100, or other components described herein can each include at least one processing circuit. Such a processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store, such as the access-restricted data store 206, can be stored in the one or more storage devices.

The device management engine 219, the policy engine 216, the media transcription engine 213, the client application 253, and other components described herein can be embodied in the form of hardware, as software components that are executable by hardware, or as a combination of software and hardware. If embodied as hardware, the components described herein can be implemented as a circuit or state machine that employs any suitable hardware technology. Such hardware technology can include one or more microprocessors, discrete logic circuits having logic gates for implementing various logic functions upon an application of one or more data signals, application specific integrated circuits (ASICS) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. Such a computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, the following is claimed:

1. A system, comprising:
a computing device comprising a processor and a memory; and
an application stored in the memory of the computing device that, when executed by the processor of the computing device, causes the computing device to at least:
receive a request for media content from a client device;
receive a device identifier and a current device context associated with the client device;
identify a policy applicable to the requested media content based at least in part on the current device context or the device identifier; and
select a component of the media content to send to the client device based at least in part on the applicable policy; and
provide the client device with access to the selected component.

2. The system of claim 1, wherein the application, when executed by the processor of the computing device, further causes the computing device to at least:
determine that the component of the media content is unavailable; and
send a request to a media transcription engine to generate the component of the media content.

3. The system of claim 1, wherein the application, when executed by the processor of the computing device, further causes the computing device to at least encrypt the selected component of the media content.

4. The system of claim 1, wherein the component of the media content is stored in encrypted form.

5. The system of claim 1, wherein the component of the media content comprises at least one of a video component, an image component, an audio component, or a transcript.

6. The system of claim 1, wherein the policy defines whether the client device is authorized to access the component of the media content based at least in part on the current device context.

7. The system of claim 1, wherein the current device context comprises at least one of a current location of the client device, a bandwidth of a network connection between the client device and the computing device, a type of network connection between the client device and the computing device, an identification of a current network to which the client device is connected, an ownership status of the client device, or a balance of a data allotment associated with a network account used by the client device to access the network.

8. A method, comprising:
receiving a request for media content from a client device;
receiving a device identifier and a current device context associated with the client device;
identifying a policy applicable to the requested media content based at least in part on the current device context or the device identifier; and
selecting a component of the media content to send to the client device based at least in part on the applicable policy; and
providing the client device with access to the selected component.

9. The method of claim 8, further comprising:
determining that the component of the media content is unavailable; and
sending a request to a media transcription engine to generate the component of the media content.

10. The method of claim 8, further comprising encrypting the selected component of the media content.

11. The method of claim 8, wherein the selected component of the media content is stored in encrypted form.

12. The method of claim 8, wherein the component of the media content comprises at least one of a video component, an image component, an audio component, or a transcript.

13. The method of claim 8, wherein the policy defines whether the client device is authorized to access the component of the media content based at least in part on the current device context.

14. The method of claim 8, wherein the current device context comprises at least one of a current location of the client device, a bandwidth of a network connection between the client device and the computing device, a type of network connection between the client device and the computing device, an identification of a current network to which the client device is connected, an ownership status of the client device, or a balance of a data allotment associated with a network account used by the client device to access the network.

15. A non-transitory computer-readable medium storing a plurality of computer instructions executable by a computing device, the plurality of computer instructions being configured to cause the computing device to at least:
receive a request for media content from a client device;
receive a device identifier and a current device context associated with the client device;
identify a policy applicable to the requested media content based at least in part on the current device context or the device identifier; and
select a component of the media content to send to the client device based at least in part on the applicable policy; and
provide the client device with access to the selected component.

16. The non-transitory computer-readable medium of claim 15, wherein the plurality of computer instructions are further configured to cause the computing device to at least:
determine that the component of the media content is unavailable; and
send a request to a media transcription engine to generate the component of the media content.

17. The non-transitory computer-readable medium of claim 15, wherein the current device context comprises at least one of a current location of the client device, a bandwidth of a network connection between the client device and the computing device, a type of network connection between the client device and the computing device, an identification of a current network to which the client device is connected, an ownership status of the client device, or a balance of a data allotment associated with a network account used by the client device to access the network.

18. The non-transitory computer-readable medium of claim 17, wherein the policy defines whether the client device is authorized to access the component of the media content based at least in part on the current device context and the plurality of computer instructions are further configured to cause the computing device to at least:
identify the current location of the client device; and
determine that the current location of the client device is an authorized location for the client device to receive the component of the media content, wherein the policy specifies the authorized location.

19. The non-transitory computer-readable medium of claim 17, wherein the policy defines whether the client device is authorized to access the component of the media content based at least in part on the current device context and the plurality of computer instructions are further configured to cause the computing device to at least:
determine the bandwidth of the network connection between the client device and the computing device; and
determine that the bandwidth of the network connection exceeds a minimum bandwidth required for the client device to be authorized to receive the component of the media content, wherein the policy specifies the minimum bandwidth.

20. The non-transitory computer-readable medium of claim 17, wherein the policy defines whether the client device is authorized to access the component of the media content based at least in part on the current device context and the plurality of computer instructions are further configured to cause the computing device to at least:
determine a service set identifier (SSID) for the current network to which the client device is connected; and
determine that the SSID matches an authorized SSID of an authorized network for which the client device is authorized to receive the component of the media content when connected to the authorized network, wherein the policy specifies the authorized SSID.
